(19) United States
(12) Patent Application Publication
(10) Pub. No.: US 2013/0180974 A1
(43) Pub. Date: Jul. 18, 2013

(54) Versatile Head and Neck Apparel with Magnetic Clasp

(71) Applicant: Donna WILSON, Downers Grove, IL (US)

(72) Inventor: Donna WILSON, Downers Grove, IL (US)

(21) Appl. No.: 13/649,393

(22) Filed: Oct. 11, 2012

Related U.S. Application Data
(60) Provisional application No. 61/631,952, filed on Jan. 12, 2012.

(51) Int. Cl. A42B 5/00; H05B 3/00

(52) U.S. Cl. 219/211; 2/207

(57) ABSTRACT

This invention relates to a type of apparel specifically shaped and sized to allow for a plurality of uses as a scarf, wrap, or headpiece, further comprising one or more pairs of magnetic fasteners to secure the garment in a predetermined configuration.

### CROSS REFERENCE TO RELATED APPLICATIONS

This patent application claims priority to U.S. provisional patent application 61/631,952, filed Jan. 12, 2012, pursuant to 35 USC 119(e).

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

Field of the Invention

Conventional scarves can be bulky in nature due to excessive material used for design. In order to close a conventional scarf for warmth it must be wrapped around neck multiple times and knotted, pinned or otherwise secured. In addition to sacrificing convenience of dressing and undressing, conventional configurations are also limited in their warming efficiency, as gaps tend to open between the loops of cloth, and gaps are raised between the skin and the garment where the material has bunched.

Conventional scarves also do not fit well in standard pockets or purses, often requiring bunching or folding which requires ample space and often results in a wrinkled garment.

Scarves of the “neck warmer” or “gaiter” variety are manufactured to be tubular in their design and shape, requiring the individual wearer to pull garment over his/her head creating friction and static charge. In addition to the inconvenience of pulling a garment over the head, the act of removal often musses the hair and makeup of the wearer, and accumulates makeup stains on the garment.

In regards to scarf/hat combinations, typically garment designs that can be worn as both are joined together as a hooded scarf made of multiple layers and angles of fabric. With these types of prior art constructions, a hooded portion would be placed on the head and a shawl style scarf would be wrapped around the back, shoulders and neck; fastened in front by tying a knot. These garments can shift while being worn and are unable to be worn with a coat because of all the bulky material required for design.

What is needed is a type of apparel comprising two or more magnetic fasteners, specifically shaped and sized so as to allow for a plurality of methods of use as a fitted scarf, wrap and/or headpiece.

### BACKGROUND OF THE INVENTION

The current state of knowledge is as follows.

A neck and head garment of concave ellipse shape with a hidden magnet positioned at each end; thus providing an efficient and quick means for attaching and detaching garment. The garment's design, size, shape and magnetic closure system enables individual to wear as a hat with open top or scarf with design versatility. The addition of the magnetic closure system allows the utility of magnetically attaching any metal accessory such as a broach, barrette, or decorative pin to garment without the need of pinning

### BRIEF SUMMARY OF THE INVENTION

The novel components of this work are the specific shaping and sizing of the garment, which configuration allows for a snug fit without bunching or hanging fabric, as well as the use of magnetic fasteners which provides for an ease of securing and removing the garment without the need for knotting, pinning or other less convenient means of securement.

In a preferred embodiment is provided the A garment comprising one or more layers of material cut in a concave ellipsoid shape, further comprising one or more pairs of clasp magnets secured within the garment such that the magnets overlap and bond when the garment is worn as a scarf or head piece.

In another preferred embodiment, the disclosed garment, further comprising wherein the clasp magnets are stitched between layers of fabric.

In another preferred embodiment, the disclosed garment, further comprising wherein the clasp magnets are adhered between layers of fabric or to the exterior of fabric using an adhesive.

In another preferred embodiment, the disclosed garment, further comprising wherein the adhesive is from the group comprising: cryanoacrylate, polyurethane, basting glue or thermoplastic adhesive.

In another preferred embodiment, the disclosed garment, further comprising wherein fitted pockets are located on the garment for removable placement of the clasp magnets.

In another preferred embodiment, the disclosed garment, further comprising wherein the clasp magnets are circular.

In another preferred embodiment, the disclosed garment, further comprising wherein the clasp magnets have a diameter between 8 mm and 24 mm and a depth between 1.5 mm and 1 cm.

In another preferred embodiment, the disclosed garment, further comprising wherein the clasp magnets have a diameter between 12 mm and 20 mm and a depth of approximately 3 mm.

In another preferred embodiment, the disclosed garment, further comprising wherein the garment measures between 6″ and 10″ from the apex to the center of the plane between the ends, and the distance between the ends measures between 22″ and 26″.

In another preferred embodiment, the disclosed garment, further comprising wherein the garment measures between 8″ and 9″ from the apex to the center of the plane between the ends, and the distance between the ends measures between 23″ and 24″.

In another preferred embodiment, the disclosed garment, further comprising wherein the clasp magnets are taken from the group comprising: metallic, ceramic (ferrite), injection-molded, flexible and alnico.

In another preferred embodiment, the disclosed garment, further comprising wherein the clasp magnets are neodymium magnets.

In another preferred embodiment, the disclosed garment, further comprising one or more metallic and/or magnetized accessories magnetically secured to the outer surface of the garment via the magnetic pull of the underlying clasp magnet.

In another preferred embodiment, the disclosed garment, one or more weighting elements.

In another preferred embodiment, the disclosed garment, further comprising heating wires within the layers of fabric attached to a power source.

In another preferred embodiment, garment comprising: one or more layers of material cut in a concave ellipsoid shape; one or more pairs of circular neodymium clasp magnets, each magnet measuring approximately 12 mm to 20 mm in diameter and approximately 3 mm in depth and secured within the garment such that the magnets overlap and bond when the garment is worn as a scarf or head piece; and optionally comprising weighting elements, heating wires attached to a power source and/or one or more metallic and/or magnetized accessories magnetically secured to the outer surface of the garment via the magnetic pull of the underlying clasp magnet.

### BRIEF DESCRIPTION OF THE DRAWINGS

FIG. 1 is a line drawing of a concave ellipsoid shape, with dotted lines evidencing the placement of magnets and two lines marking dimensions.

FIG. 2 is a line drawing evidencing the concave ellipsoid shape folded over with the magnets overlapping.

FIG. 3 is a line drawing of the garment worn as a scarf.

FIG. 4 is a line drawing of the garment worn as a scarf with a metallic decorative barrette secured to the outer magnet.

### DETAILED DESCRIPTION OF THE INVENTION

### Definitions

The following definitions are provided as an aid to understanding the detailed description of the present invention.

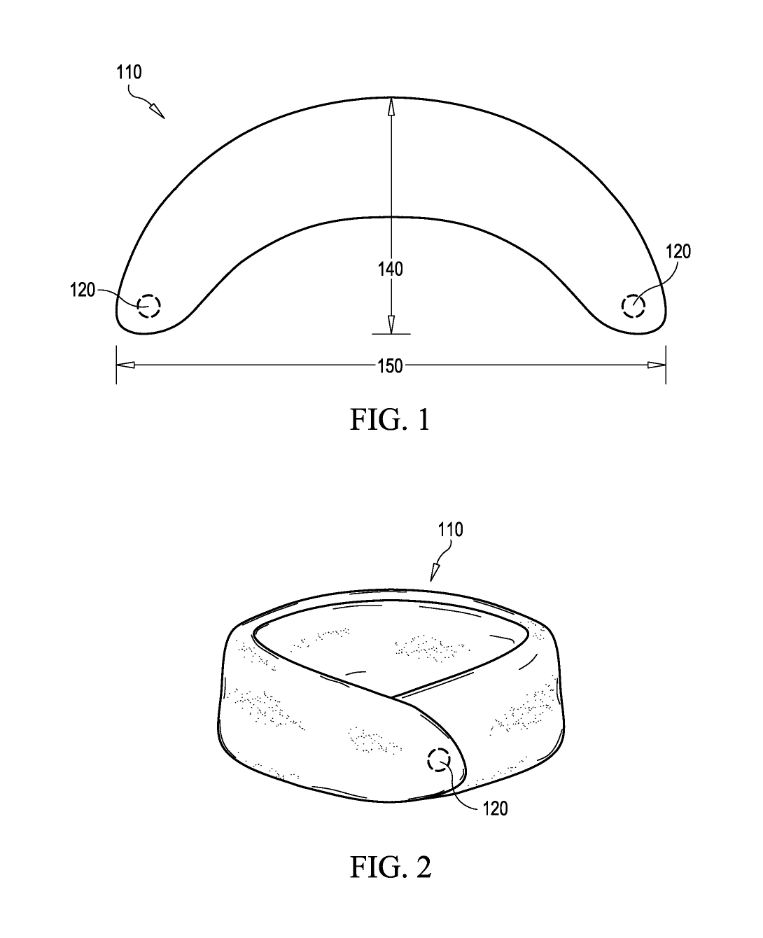

The phrase “concave ellipse” shall mean a boomerang, or lune-like shape comprising rounded or curved ends, as opposed to sharply pointed ends, as exemplified in FIG. 1.

The word “magnet” shall an object creating its own persistent magnetic field and comprising positive and negative poles, each of which is attracted to another object.

The word “weighting element” means an object comprised within the present invention with a purpose of weighting the garment to avoid displacement of the garment due to wind or movement of the wearer.

### Garment Shape

One object of the invention is to provide an improved scarf shape that follows the natural shape of the neck for comfort, warmth, and style. One preferred shape is a concave ellipse, which allows the garment to lay flat against the skin around the neck and dropping to the upper chest in front, at which point the garment overlaps itself and allows for the embedded or attached magnets to overlap and bond.

The concave ellipsoid shape, employed as a scarf, results in a garment that fits snugly around the wearer's neck without using multiple loops and without creating bunches in the fabric. The same shape may be sized up or down to fit the neck circumference of the wearer.

This same shape, employed as a head wrap, allows for a single wrap over the ears, providing a greater depth of material covering the back of the head, with the point of magnetic attachment at either the temple or forehead, or the lower back of the head above the neckline. Again, the garment may be sized up or down to fit varying head circumference.

The concave ellipsoid shape further allows for the wearer to employ a decorative flourish by twisting or turning the garment one or more times prior to securing the magnets. This method of decorative use is enhanced by the use of different or differently colored materials for the front and back of the garment.

Further, the disclosed shape and configuration allows the wearer to don the garment as a scarf and leave it in place while putting on and/or removing an overlaying jacket or coat.

In a preferred embodiment, the distance from apex to the center of the line between the ends, marked on FIG. 1 as line A, is between 6″ and 10″, and the distance from end to end, marked on FIG. 1 as line B, is between 22″ and 26″.

In a more preferred embodiment, the distance from apex to the center of the line between the ends, marked on FIG. 1 as line A, is between 8″ and 9″, and the distance from end to end, marked on FIG. 1 as line B, is between 23″ and 24″.

### Magnetic Clasps or Fasteners

The present invention comprises a magnetic clasping mechanism. Such mechanism allows the wearer to secure or release the garment with one hand. As opposed to the currently available methods of securing scarf-like garments, such as knotting or pinning, a magnetic system provides convenience and time savings to all users, and provides an especially significant improvement for individuals suffering from joint pain such as arthritis.

The use of magnets as devices for securing moving parts is known. Examples include magnetized jewelry clasps, electronic cable connections, cabinet door hardware, eyeglass components, etc.

In the present inventions, magnets would generally be sewn within the fabric of the garment, and therefore hidden. For example, a flat magnet of any shape would be circumnavigated by stitching between two folds of material for stabilization near one end of a lune-shaped garment. A magnet of identical dimensions would be similarly secured at the same position on the opposite end of the garment. The positioning of the magnets would be such that the magnets would meet at a point of garment overlap, such that the opposite poles of the magnets would attract one another and form a bond at the point of attachment.

Variations of this placement method would exist for different types of material. For example, a scarf garment comprising an upper layer of faux or natural fur and a fabric lining could similarly be secured between the two layers, either by stitching or adhesive.

Shapes of magnets comprised within the invention may be chosen from the group including, without limitation: circular, square, rectangular, or triangular.

As an alternative to the permanent fixation of magnets within the garment, sealable pockets, using velcro, a fabric overlap or similar design, could be placed on the underside of the garment into which removable magnets could be placed.

The magnets themselves may be chosen from a variety of types, including but not limited to magnetic metals from the group comprising iron, aluminum, cobalt, nickel or rare earth metals. Alternatively, the magnets may be chosen from the group comprising any commercially available composite or synthetic magnets such as ceramics (ferrite), alnico, injection-molded magnets or flexible magnets.

A neodymium (or “neo”) magnet (also known as NdFeB, NIB, or Neo magnet), the most widely-used type of permanent rare earth magnet, is made from an alloy of neodymium, iron and boron to form the Nd2Fel4B tetragonal crystalline structure. Neo magnets are known for superior strength of magnetic field when compared to other commercially available magnets of similar dimension.

Ceramic, or ferrite, magnets are made of a sintered composite of powdered iron oxide and barium/strontium carbonate ceramic. Given the low cost of the materials and manufacturing methods, inexpensive magnets of various shapes can be easily mass-produced. The resulting magnets are non-corroding but brittle and must be treated like other ceramics.

Alnico magnets are made by casting or sintering a combination of aluminum, nickel and cobalt with iron and small amounts of other elements added to enhance the properties of the magnet. Sintering offers superior mechanical characteristics, whereas casting delivers higher magnetic fields and allows for the design of intricate shapes Alnico magnets resist corrosion and have physical properties more forgiving than ferrite, but not quite as desirable as a metal.

Injection-molded magnets are a composite of various types of resin and magnetic powders, allowing parts of complex shapes to be manufactured by injection molding. The physical and magnetic properties of the product depend on the raw materials, but are generally lower in magnetic strength and resemble plastics in their physical properties.

Flexible magnets are similar to injection-molded magnets, using a flexible resin or binder such as vinyl, and produced in flat strips, shapes or sheets. These magnets are lower in magnetic strength but can be very flexible, depending on the binder used.

In a preferred embodiment, the invention comprises two flat, circular magnets, each with a diameter between 8 mm and 24 mm and a depth between 1.5 mm and 1 cm.

In a more preferred embodiment, the invention comprises two flat, circular magnets, each with a diameter between 12 mm and 20 mm and a depth of approximately 3 mm.

In another preferred embodiment, the invention comprises more than one pair of magnets to provide multiple points of attachment.

In a more preferred embodiment, the invention comprises two pairs of magnets providing two separate points of attachment.

In another embodiment, one or both of the magnets in a given pair are adhered to the exterior surface of the garment instead of sewn or otherwise secured within the garment, using one or more appropriate commercially available adhesives from the group comprising, without limitation, cyanoacrylates, basting glue, fabric stiffener, polyurethane, polyester resin, polyols, acrylic polymers, polychloroprene or similar contact adhesive, thermoplastic adhesives, acrylic glue, or epoxy resin.

The presence of magnet clasps within or on the garment further provides a point of attachment for metallic or magnetized accessories, again without requiring sewing or pinning In a preferred embodiment, one or more metallic or magnetized decorative accessories, such as broaches or barrettes, are secured to the outer surface of the garment over an outer magnetic clasp after the garment has been donned.

In another preferred embodiment, functional accessories comprising metal or magnets may be attached to the outer surface of the garment over an outer magnetic clasp via the magnetic pull of the underlying clasp magnet. Such accessories or devices could include, without limitation, time pieces, GPS devices, compasses or eyeglasses.

### Other Features

Traditional scarves have a tendency to shift due to wind or movement of the wearer. This problem is especially acute for people wearing the garment while participating in sports or physical activities, such as skiing.

In a preferred embodiment, the present invention comprises one or more weighting elements to prevent shifting or repositioning of the garment once it is in place, whether from wind or from movement of the wearer. By way of example and not limitation, such weighting elements could be sewn or adhered within the fabric layers of the garments by methods disclosed herein related to magnets (e.g., sewing or by adhesives).

In another preferred embodiment, the weighting elements could comprise materials from the group including, without limitation, sand or metallic beads.

Apparel comprising heating elements, often in the form of metallic wires or threads, is known. Self-heated socks, most noticeably, have long been marketed to hunters and skiers.

In another preferred embodiment, the present invention comprises one or more heating elements connected to a power source. In another preferred embodiment, the heating elements comprise a plurality of metallic wires or threads. In more preferred embodiment, the heating elements are attached to a commercially available battery power source, from the group including, but not limited to, a AAA, AA, C, D, LR44 or 9-volt.

### DETAILED FIGURES DESCRIPTIONS

Referring now to the Figures, FIG. 1 is a line drawing evidencing an open garment 110 cut in the concave ellipsoid shape, with a magnet 120 sewn within each end, with each magnet's evidenced by a circular broken line. Line 140 measures the distance between the apex and the center of the plane between the two ends, and line 150 measures the distance between the two ends.

Referring now to the Figures, FIG. 2 is a line drawing evidencing garment 110 cut in the concave ellipsoid shape but resting in the overlap position, with the position of the overlapping magnets 120 evidenced by a circular broken line.

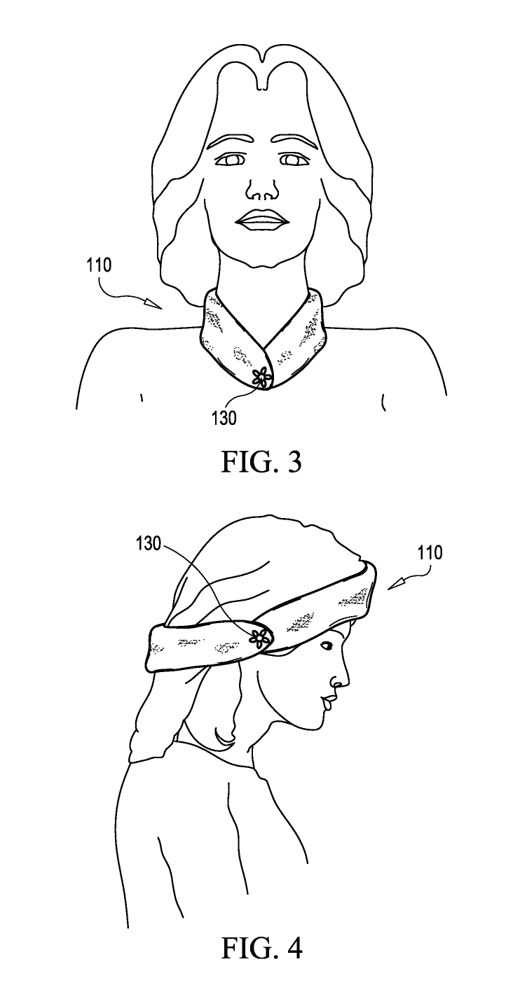

Referring now to the Figures, FIG. 3 is a line drawing of garment 110 being worn as a scarf, wrapped around the neck and shoulders of the wearer, with a decorative, magnetized broach 130 affixed over magnets 120 (not shown).

Referring now to the Figures, FIG. 4 is a line drawing of garment 110 being worn as a head piece, wrapped around the head of the wearer with magnets 120 (not shown) affixing over the wearer's temple, with decorative broach 130 affixed over the magnets.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

I claim:

1. A garment comprising one or more layers of material cut in a concave ellipsoid shape, further comprising one or more pairs of clasp magnets secured within the garment such that the magnets overlap and bond when the garment is worn as a scarf or head piece.

2. The garment of claim 1, further comprising wherein the clasp magnets are stitched between layers of fabric.

3. The garment of claim 1, further comprising wherein the clasp magnets are adhered between layers of fabric or to the exterior of fabric using an adhesive.

4. The garment of claim 3, further comprising wherein the adhesive is from the group comprising:
cryanoacrylate, polyurethane, basting glue or thermoplastic adhesive.

5. The garment of claim 1, further comprising wherein fitted pockets are located on the garment for removable placement of the clasp magnets.

6. The garment of claim 1, further comprising wherein the clasp magnets are circular.

7. The garment of claim 6, further comprising wherein the clasp magnets have a diameter between 8 mm and 24 mm and a depth between 1.5 mm and 1 cm.

8. The garment of claim 6, further comprising wherein the clasp magnets have a diameter between 12 mm and 20 mm and a depth of approximately 3 mm.

9. The garment of claim 1, further comprising wherein the garment measures between 6″ and 10″ from the apex to the center of the plane between the ends, and the distance between the ends measures between 22″ and 26″.

10. The garment of claim 1, further comprising wherein the garment measures between 8″ and 9″ from the apex to the center of the plane between the ends, and the distance between the ends measures between 23″ and 24″.

11. The garment of claim 1, further comprising wherein the clasp magnets are taken from the group comprising: metallic, ceramic (ferrite), injection-molded, flexible and alnico.

12. The garment of claim 1, further comprising wherein the clasp magnets are neodymium magnets.

13. The garment of claim 1, further comprising one or more metallic and/or magnetized accessories magnetically secured to the outer surface of the garment via the magnetic pull of the underlying clasp magnet.

14. The garment of claim 1, one or more weighting elements.

15. The garment of claim 1, further comprising heating wires within the layers of fabric attached to a power source.

16. A garment comprising: one or more layers of material cut in a concave ellipsoid shape; one or more pairs of circular neodymium clasp magnets, each magnet measuring approximately 12 mm to 20 mm in diameter and approximately 3 mm in depth and secured within the garment such that the magnets overlap and bond when the garment is worn as a scarf or head piece; and optionally comprising weighting elements, heating wires attached to a power source and/or one or more metallic and/or magnetized accessories magnetically secured to the outer surface of the garment via the magnetic pull of the underlying clasp magnet.
